(19) United States
(12) Patent Application Publication
(10) Pub. No.: US 2012/0082858 A1
(43) Pub. Date: Apr. 5, 2012

(54) Method of Manufacturing Water-Resistant Gypsum Articles and Articles Formed Thereby

(75) Inventor: Andrzej A. Przybysz, Chicago, IL (US)

(73) Assignee: GEORGIA-PACIFIC GYPSUM LLC, Atlanta, GA (US)

(21) Appl. No.: 12/974,483

(22) Filed: Dec. 21, 2010

Related U.S. Application Data
(60) Provisional application No. 61/289,150, filed on Dec. 22, 2009.

(51) Int. Cl. B32B 29/00; C04B 16/00; C04B 24/36; B01F 3/08; C08K 3/00; B32B 37/15; B01F 11/02; C04B 28/14; C04B 24/08

(52) U.S. Cl. 428/447; 106/772; 106/660; 106/668; 106/661; 106/781; 524/3; 524/2; 106/778; 156/41; 366/108

(57) ABSTRACT

A method of manufacturing a water-resistant gypsum article, comprising sonicating a water-resistance additive in water to form a emulsion; combining the emulsion, calcined gypsum, and gauging water to form a slurry; and forming and setting the slurry to form the water-resistant gypsum article.

### BACKGROUND OF THE INVENTION

The present disclosure generally relates to an improved method of manufacturing water-resistant gypsum articles and, more particularly, to reducing the amount of water-resistance additive required to manufacture water-resistant gypsum articles.

Gypsum is a naturally occurring mineral which can be found in old salt-lake beds, volcanic deposits and clay beds. In chemical terms, gypsum is calcium sulfate dihydrate (CaSO₄.2H₂O). This material is produced also as a by-product in various industrial processes.

When calcium sulfate dihydrate is heated sufficiently, a process called calcining, the water of hydration is driven off and there can be formed either calcium sulfate hemihydrate (CaSO₄.1/2H₂O) or calcium sulfate anhydrite (CaSO₄), depending on the temperature and duration of exposure. The term “calcined gypsum,” as used herein, refers to both the hemihydrate and anhydrite forms of calcium sulfate.

Calcined gypsum is capable of reacting with water to form calcium sulfate dihydrate, which is a fairly hard and rigid product and which is referred to herein as “set gypsum.”

An example of a common gypsum product is gypsum board, which is widely used as a structural building panel. Speaking generally, gypsum board comprises a core made from an aqueous slurry of calcined gypsum which hydrates to form set gypsum. Typically, the board has a lining adhered to both of its faces. Common linings can comprise a paper sheet or a glass fiber mat.

A characteristic of set gypsum is that it has a tendency to absorb water. To illustrate, a gypsum core containing no water-resistance additives can absorb as much as 40 to 50 weight percent (wt. %) water when immersed therein at a temperature of 70 degrees Fahrenheit (° F.) for about two hours. In applications where the gypsum product is exposed to water or high humidity, this characteristic is undesirable. The absorption of water by the gypsum tends to reduce the strength of the product, to render the product vulnerable to microbiological growth, and to cause the facings to delaminate.

Gypsum board may be used, for example, on the exterior of buildings where it serves as an underlying surface which is covered with such materials as aluminum or wood siding. This type of gypsum board is commonly referred to as “gypsum sheathing,” and is often subjected to significant exposure to water and/or humidity, Gypsum board also may be used in bathrooms as an underlying surface, which is covered with plastic or ceramic tile and for this purpose it is often referred to as a “tile-backing board.” In applications such as these, it is important that the gypsum board exhibit good water resistance.

Many different additives have been reported as being effective for imparting water resistance to gypsum products. Examples of some water-resistance additives include wax, asphalt, metallic resonates, organic thermoplastic polymers, including synthetic thermoplastic polymers, siloxanes, siliconates, and the like. Because of the hydrophobic nature associated with their water-resistant properties, however, they are insoluble in water. As gypsum products are generally formed from an aqueous slurry of calcined gypsum, it is difficult to disperse adequately such water-resistance additives in the gypsum. A common solution is to emulsify the hydrophobic additive in water, and to add this to the gypsum slurry. Current methods of emulsifying the water-resistance additives, however, result in inadequate dispersion of the additive, which can require more additive to be added to the gypsum slurry than is necessary to meet absorption targets. For some of the water-resistance additives, such as siloxane, this can result in significantly increased material and operating costs.

Accordingly, there remains a need for an improved method of manufacturing a water-resistant gypsum article.

### BRIEF DESCRIPTION OF THE INVENTION

Disclosed herein are methods for manufacturing water-resistant gypsum articles. In one embodiment, the method of manufacturing a water-resistant gypsum article, comprises sonicating a water-resistance additive in water with a sonication device configured to impart ultrasonic energy to the additive and the water to form an emulsion; combining the emulsion, gauging water, and calcined gypsum to form a gypsum slurry; and forming and setting the gypsum slurry to from the water-resistant gypsum article.

In another embodiment, the method comprises sonicating a water-resistance additive in water with a sonication device configured to impart ultrasonic energy to the additive and the water, to form a emulsion; combining the emulsion, calcined gypsum, and gauging water to form a gypsum slurry; dispensing the gypsum slurry onto a first facing sheet; disposing a second facing sheet on a side of the dispensed gypsum slurry opposite the first facing sheet; and setting the gypsum slurry to form the water-resistant gypsum board.

In another embodiment, a water-resistant gypsum board comprises a gypsum core having a planar first face and a second face, wherein the core comprises about 0.01 weight percent to about 20 weight percent of organopolysiloxane, siliconate, or a combination comprising at least one of the foregoing, based on the total weight of the ingredients in the core, exclusive of gauging water; and a facing material adhered to at least the first face of the gypsum core.

In still another embodiment, a system for producing a water-resistant gypsum slurry comprises a sonication device configured to impart ultrasonic energy on a water-resistance additive in water to substantially completely disperse the water-resistance additive in the water and form a emulsion; and a pin mixer in fluid communication with the sonication device, wherein the pin mixer is configured to thoroughly mix a calcined gypsum, gauging water, and the emulsion to form a gypsum slurry.

The above described and other features are exemplified by the following figures and detailed description.

### BRIEF DESCRIPTION OF THE DRAWINGS

Referring now to the FIGURE, wherein the like elements are numbered alike, the FIGURE is a schematic of an exemplary embodiment of a system for forming an emulsion and mixing it into a gypsum slurry.

### DETAILED DESCRIPTION OF THE INVENTION

Disclosed herein are methods for manufacturing water-resistant gypsum articles, in particular gypsum boards. In one embodiment, a method for manufacturing a water-resistant gypsum article includes sonicating a water-resistance additive with water to form an emulsion; mixing the emulsion with calcined gypsum and water to form an aqueous gypsum shiny; and forming and setting the slurry to form a water-resistant gypsum article. Sonication of the water-resistance additive with the water can be accomplished using any device configured to impart ultrasonic energy to the additive and water. After mixing with calcined gypsum, the settable slurry can be shaped during setting to form a set gypsum-based, water-resistant article, such as a gypsum board.

Fast, thorough dispersion of water-resistance additives into a gypsum slurry is desirable. A thorough dispersion of the water-resistance additive in the slurry will result in a water-resistant gypsum article having uniform water-resistant properties throughout. Inconsistent mixing and uneven dispersion of the water-resistance additive in the slurry can lead to a gypsum article with irregular, discontinuous water-resistant properties, thereby negatively affecting the durability of the article in wet and/or humid conditions. As mentioned above, in an attempt to avoid this uneven dispersion, current methods of manufacturing gypsum slurries use greater amounts of additives than are necessary to achieve target absorption rates were the additive able to be uniformly dispersed. By using excess amounts of water-resistance additives, the material costs associated with the manufacture of water-resistant gypsum articles become higher. The cost of particular types of water-resistance additives (e.g., siloxane) can be expensive. It is, therefore, desirable to use the minimum amount of water-resistance additive necessary to provide uniform water-resistant properties to the gypsum article. The methods as described herein sonicate the water-resistance additives using ultrasonic energy to form a substantially complete dispersion of the water-resistance additive in water. Substantially complete dispersion of the water-resistance additive in the emulsion through sonication permits substantially complete mixing of the water-resistance additive into the gypsum slurry. Due to the substantially complete mixture in the gypsum slurry, the water-resistance additive is uniformly present throughout articles formed from the water-resistant gypsum slurry. Moreover, because of the substantially complete dispersion of the water-resistance additive in the emulsion, it is unnecessary to add excess amounts of additive to ensure absorption targets are met, as is often employed by current methods. In fact, it has been unexpectedly found that sonicating the water-resistance additive in water with ultrasonic energy results in requiring less water-resistance additive in the gypsum slurry than current standard manufacturing methods to achieve the same absorption targets.

Intensive ultrasound supplies the energy needed to substantially completely disperse the water-resistance additive in the water to form the emulsion. Ultrasonic frequency oscillations can provide the desired shearing, impacting, and pressure effect to create a uniform emulsion, wherein the additive is substantially completely dispersed. As mentioned above, the step of sonicating can be carried out with any sonication device configured to impart ultrasonic energy on the emulsion components. Typically, the sonication device has a sonication horn or probe that is inserted into a mixture of the water-resistance additive and water to emit sonic energy into the solution. In an exemplary embodiment, the sonicating device is operated at a frequency of about 1 kilohertz (kHz) to about 90 kHz; specifically from about 20 kHz to about 40 kHz or any range or combination of ranges therein. An exemplary sonication device is an ultrasonic processor. Ultrasonic processors impart ultrasound energy to one or more liquids for sonication, including, without limitation, homogenizing, disintegration, emulsifying, dispersing, particle size reduction (milling), and the like. An exemplary ultrasonic processor for use as described herein is the UIP1000hd manufactured by Hieschler Ultrasonics®.

A variety of water-resistance additives can be employed in the methods of manufacture described herein. The type of water-resistance additive used will depend, in part, on the desired article to be formed from the gypsum slurry. Exemplary articles can include, without limitation, gypsum structural products commonly known as gypsum wallboard, dry wall, gypsum board, tile-backing board, gypsum lath, and gypsum sheathing. The set, water-resistant gypsum would comprise the core of these exemplary articles. In one embodiment, the desired water-resistance of the gypsum structural product (e.g., wallboard) is such that it absorbs less than about 10%, specifically less than about 7.5%, and more specifically less than about 5% water when tested in accordance with the immersion test of ASTM method C-473.

Exemplary water-resistance additives can include, without limitation, wax or a wax emulsion, metallic resonates, cornflower and potassium permanganate, water-insoluble thermoplastic organic materials such as petroleum, natural asphalt, pine tar, and coal tar, thermoplastic synthetic polymers such as poly(vinyl acetate), poly(vinyl chloride), a copolymer of vinyl acetate and vinyl chloride, and acrylic polymers, metal rosin soap, water-soluble alkaline earth metal salts, fuel oil, aromatic isocyanates and diisocyanates, organopolysiloxanes such as organohydrogen-polysiloxanes, siliconates, mixtures of the foregoing, and the like. In one embodiment, two or more water-resistance additives can be included in the gypsum slurry, and the method described herein is effective in reducing the amount of water-resistance additive required for at least one of the additives when compared to the amount required for existing methods of manufacturing water-resistant gypsum compositions t achieve substantially similar water-resistant properties. In an exemplary embodiment, for the methods described herein, the water-resistance additives comprise a organopolysiloxane, siliconate, or a combination thereof. Exemplary organopolysiloxanes can include, for example, the types referred to in U.S. Pat. Nos. 3,455,710; 3,623,895; 4,136,687; 4,447,498; and 4,643,771. One example of this type of organopolysiloxane water-resistance additive is poly(methyl hydrogen siloxane).

The water-resistance additive is used in an amount effective to achieve the absorption targets described above. The actual amount will depend on a variety factors, such as the type of water-resistance additive(s) used, the product to be formed from the composition, the desired density of the product, and the like. Taking such factors into account, the water resistance additive is added in an amount effective to provide about 0.01 wt % to about 30 wt %, specifically about 0.1 to about 15 wt %, more specifically about 1 to about 10 wt % of the additive. For example, when using siloxane as a water-resistance additive, the gypsum composition from which the set product is made comprises about 0.01 wt % to about 20 wt %; specifically about 0.1 wt % to about 15 wt %; and more specifically about 1 wt % to about 10 wt % of siloxane. Stated in another way, the amount of siloxane required in the gypsum composition formed by the methods described herein represent a reduction of about 1% to about 20%; specifically about 5% to about 18%; and more specifically about 10% to about 17% compared to the amount of siloxane required for methods known in the art. Similarly, when using siliconate as a water-resistance additive, the gypsum composition from which the set product is made comprises about 0.01 wt % to about 20 wt %; specifically about 0.1 wt % to about 15 wt %; and more specifically about 1 wt % to about 10 wt % of the additive. Again, in another perspective, the amount of siliconate required in the gypsum composition formed by the methods described herein represent a reduction of about 1% to about 50%; specifically about 10% to about 40%; and more specifically about 20% to about 30% compared to the amount of siliconate required for methods known in the art. When siloxane and siliconate are used as water-resistance additives in combination, the siloxane can comprise about 0.01 wt % to about 20 wt %; specifically about 0.1 wt % to about 15 wt %; and more specifically about 1 wt % to about 10 wt % of the additive.

Unless stated otherwise, the term “wt %” as used herein in connection with the water resistance additive means weight percent based on the total weight of the ingredients of the composition from which the set gypsum article is made, including any water of the emulsion, but not including additional amounts of water that are added to the gypsum composition for forming an aqueous slurry thereof.

Apart from the inventive method of sonicating the water-resistance additive in water to form the emulsion and combining the emulsion with the gypsum slurry, the gypsum composition of the present disclosure can be produced according to conventional methods. Generally, this initially involves combining water, gypsum and any other dry ingredients in a mixer to form an aqueous shiny. The emulsion can be combined with the gypsum as the aqueous slurry is being generated, or the emulsion can be added after the gypsum slurry has been formed. In an exemplary embodiment, the emulsion is added as the gypsum slurry is being formed. The essential ingredients for use in preparing the water-resistant gypsum compositions of the present disclosure are calcined gypsum, water and the emulsion. As described more fully below, the composition is made from an aqueous slimy of the calcined gypsum and other constituents including the emulsion. In conventional fashion, the components of the slurry (except the emulsion) are pre-mixed as dry ingredients and then fed to a mixer of the type commonly referred to as a pin mixer. Water and other liquid constituents, including the emulsion are then metered into the pin mixer where they are combined with the desired dry ingredients to form the aqueous gypsum slurry.

The major ingredient of the water-resistant gypsum composition is calcined gypsum that is capable of hydrating with water to form set gypsum. Thus, anhydrous calcium sulfate or the hemihydrate of calcium sulfate can be used, including the alpha or beta form thereof. In manufacturing gypsum products, for example, gypsum wallboard, it is common to form a slurry from a measured amount of calcined gypsum and an amount of water somewhat exceeding the amount necessary to hydrate the gypsum. This water added to hydrate the gypsum is sometimes referred to as “gauged” or “gauging” water. In fabricating a water-resistant gypsum composition in accordance with this disclosure, an exemplary composition includes at least about 75 wt %; specifically at least about 80 wt %; and more specifically at least about 83 wt % of calcined gypsum.

The gypsum slurry can include other optional additives, including, without limitation, set accelerators, set retardants, foaming agents, reinforcing fibers, fire-resistance additives, viscosity control agents, dispersing/emulsifying agents, and the like. For example, to reduce the weight (density) of gypsum articles, such as the gypsum core of wallboards, foaming agents or soaps, such as long-chained alkyl suflonates, can be added to the shiny. The introduction of air provided by the foaming agents is effective in reducing the density of a gypsum article. For gypsum articles such as wallboards, however, the reduction in density can affect the strength of the bond between the set gypsum core and the paper facers. To counteract this effect, starch binders can also be added to the gypsum slurry.

Emulsifying agents can be used to aid in dispersing the dry ingredients throughout the gypsum slurry. Exemplary emulsifying agents can include, without limitation, protective colloids such as polyvinyl alcohol, which may contain up to 40 mol percent acetyl groups, gelatins, organic gums, and cellulose derivatives such as water soluble methyl cellulose; anionic emulsifying agents such as alkali metal and ammonium salts of long chain fatty acids, organic sulphonic acids and acidic sulfuric acid esters, e.g. sodium laurate, sodium isopropylnaphthaline sulfonate, sodium dioctylsulfosuccinate, triethanol ammonium oleate, sodium lauryl alcohol sulfonate, and corresponding potassium, lithium, rubidium and cesium compounds; cationic emulsifying agents such as stearyl ammonium chloride; and nonionic emulsifying agents such as polyoxyethylene ethers and sorbitan monolaurate ethers of mono-or polyhydric aliphatic alcohols or aromatic hydroxy compounds. The exact nature of the emulsifying agent is not critical.

The ingredients of the slurry are mixed thoroughly in the pin mixer, with the consistency of the slurry being such that the slurry is capable of being dispensed through one or more outlets from the pin mixer onto a moving facing sheet which is carried on a conveyor belt. In the production of a gypsum article such as wallboard, typically another facing sheet is placed on top of the slurry to sandwich it between two moving facing sheets. The facing sheets can be paper, but they may also comprise another material such as, for example, plastic scrim, non-woven or woven fiberglass mat, and the like.

The thickness of the resultant board is controlled by a forming roll and the edges of the board are formed by appropriate mechanical devices which continuously score, fold and glue the overlapping edges of the facing sheets. Additional guides can be used to maintain thickness and width as the setting sluny travels on a moving belt. Desired lengths of board are cut in a continuous operation. Evaporation from the core of excess water, which is not involved in the hydration of the calcined gypsum, is generally accelerated by heating the board.

The water-resistant gypsum slurry of the present disclosure can also be used in making a “faceless” water-resistant gypsum product, that is, one that does not include a facing sheet of paper, glass mat or similar material. Such products contain typically reinforcing fibers, for example, cellulosic fibers such as wood or paper fibers, glass fibers or other mineral fibers and polypropylene or other synthetic polymer fibers. The reinforcing fibers can comprise, for example, about 10 to about 20 wt % of the dry composition from which the set gypsum product is made. The density of such a product is typically within the range of about 50 to about 80 pounds/cubic ft.

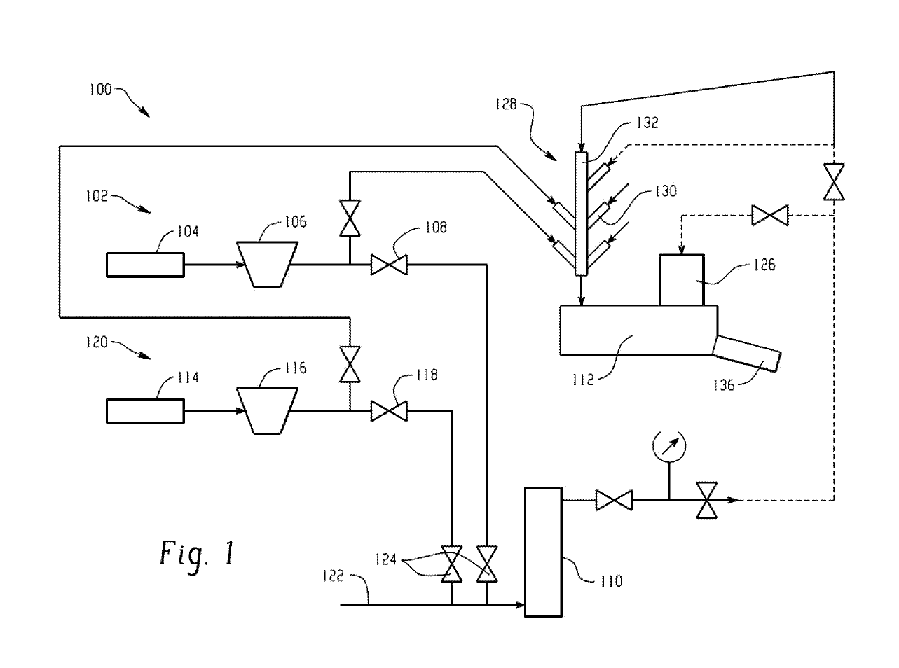

Referring now to FIG. 1, a schematic view of a portion of a system for manufacturing a water-resistant gypsum article is illustrated. In the system 100, two water-resistance additive supplies are available. The system 100 can utilize one or both water-resistance additives when forming the emulsion. In another embodiment, one of the water-resistance additives can be used to form the emulsion, while the other additive can be fed directly to the mixer configured to form the gypsum slurry. As shown in FIG. 1, a first water-resistance additive supply 102 comprises a supply pump 104, a flow meter 106, and check valves 108. The supply pump, flow meter, and check valves are together configured to control the flow of the first water-resistance additive to a sonication device 110 and/or a pin mixer 112. Similarly, a second water resistant additive supply 120, including a supply pump 114, a flow meter 116, and cheek valves 118, is configured to control the flow of the second water-resistance additive to the sonication device 110 and/or the pin mixer 112. When diverted to the sonication device 110, one or both of the water-resistance additives can be mixed with a water source 122 and fed to the sonication device 110. Valves 124 can be used to control the flow of each of the water-resistance additives and the water to the sonication device 110. The sonication device 110 is configured to form a emulsion as described in detail above. Once formed, the emulsion can be fed to the pin mixer 112 for mixing with the gypsum slurry ingredients. A valve system 124 can be disposed on the outlet side of the sonication device 110 to control the flow and pressure of the emulsion stream to the pin mixer 112.

As mentioned, the gypsum, other dry additives, and emulsion are combined with gauging water and intimately mixed in the pin mixer 112 to form the gypsum slurry. The emulsion can be fed into the pin mixer in a variety of different locations to be effectively mixed into the gypsum slurry. Examples of locations for adding the emulsion to the pin mixer 112 can include adding the emulsion through the breather 126 of the pin mixer or adding the emulsion to the gauging water prior to the water entering the mixer. In one embodiment, the emulsion can be added to the pin mixer 112 in more than one location. In an exemplary embodiment, a feed tree 128 can be used to feed one or more of the ingredients, including the emulsion, to the pin mixer 112. The feed tree 128 is configured to provide a central point to feed each of the ingredients. The feed tree can have any number of ports in which to feed the ingredients and will depend upon the number of desired ingredients for the gypsum slurry. As shown in FIG. 1, the feed tree 128 comprises 5 separate feed ports 130, one for each of the water-resistance additives, the emulsion, the gypsum, and additional optional additives. The gauging water runs down a center tube 132 of the tree to aid in washing the dry ingredients and emulsion into the main feed port of the pin mixer 112. Again, the gauging water, emulsion, and dry ingredients are metered into the pin mixer where they are combined to form an aqueous gypsum slurry, which emerges from a discharge conduit 136. The slurry can be deposited through one or more outlets in the discharge conduit 136 onto a horizontally moving continuous web of facing material (such as multi-ply papers or a pre-coated fibrous glass mat). The amount deposited can be controlled in manners known in the art.

The methods as disclosed herein sonicate a water-resistance additive with water using ultrasonic energy to form a substantially complete dispersion of the water-resistance additive in a liquid-based emulsion. Substantially complete dispersion of the water-resistance additive in the emulsion through sonication permits substantially complete mixing of the water-resistance additive into the gypsum slurry. Due to this substantially complete mixture in the gypsum slurry, the water-resistance additive is uniformly present throughout articles formed from the water-resistant gypsum slurry. Moreover, because of the substantially complete dispersion of the water-resistance additive in the emulsion, it is unnecessary to add excess amounts of additive, as is often employed by current methods. In fact, sonicating the water-resistance additive in water with ultrasonic energy requires less water-resistance additive in the gypsum slurry than current standard manufacturing methods to achieve the same absorption targets.

Ranges disclosed herein are inclusive and combinable (e.g., ranges of “up to about 25 wt %, or, more specifically, about 5 wt % to about 20 wt %”, is inclusive of the endpoints and all intermediate values of the ranges of “about 5 wt % to about 25 wt %,” etc.). “Combination” is inclusive of blends, mixtures, alloys, reaction products, and the like. Furthermore, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. The modifier “about” used in connection with a quantity is inclusive of the stated value and has the meaning dictated by context, (e.g., includes the degree of error associated with measurement of the particular quantity). The suffix “(s)” as used herein is intended to include both the singular and the plural of the term that it modifies, thereby including one or more of that term. Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

While the invention has been described with reference to exemplary embodiments, it will be understood by those skilled in the art that various changes may be made and equivalent elements may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying this invention, but that the invention will include all embodiments falling within the scope of the appended claims. Moreover, the use of the terms, first, second, etc. are used to distinguish one element from another. Furthermore, the use of the terms a, an, etc. do not denote a limitation of quantity, but rather denote the presence of at least one of the referenced items.

What is claimed is:

1. A method of manufacturing a water-resistant gypsum article, comprising:
sonicating a water-resistance additive in water with a sonication device configured to impart ultrasonic energy to the additive and the water to form an emulsion;
combining the emulsion, gauging water, and calcined gypsum to form a gypsum slurry; and
forming and setting the gypsum slurry to form the water-resistant gypsum article.

2. The method of claim 1, wherein the sonicating is at a power and for a time effective to substantially completely disperse the water-resistance additive in the water.

3. The method of claims 1-2, comprising operating the sonication device at a frequency of about 1 kilohertz to about 90 kilohertz.

4. The method of claims 1-3, further comprising adding a set accelerator, set retardant, foaming agent, reinforcing fiber, fire-resistance agent, viscosity control agent, emulsifying agent, or a combination comprising at least one of the foregoing to the emulsion and/or the slurry.

5. The method of claims 1-4, wherein the water-resistance additive comprises a wax, wax-asphalt, asphalt, metallic resonate, cornflower and potassium permanganate, water-insoluble thermoplastic organic material, thermoplastic synthetic polymer, metal rosin soap, water-soluble alkaline earth metal salt, fuel oil, aromatic isocyanate, aromatic diisocyanate, organopolysiloxane, siliconate, or a combination comprising at least one of the foregoing water-resistance additives.

6. The method of claims 1-4, further comprising adding the emulsion to the slurry in an amount effective to provide about 0.01 weight percent to about 20.0 weight percent of the water resistance additive, based on the total weight of the ingredients in the article, including the water of the emulsion and excluding gauging water.

7. The method of claims 1-4, wherein the water-resistance additive comprises poly(methyl hydrogen siloxane), a siliconate, or a combination comprising at least one of the foregoing water-resistance additives.

8. The method of claim 7, further comprising adding the emulsion to the slurry in an amount effective to provide about 0.01 weight percent to a bout 20.0 weight percent of the poly(methyl hydrogen siloxane), siliconate, or combination, based on the total weight of the ingredients in the article, including the water of the emulsion and excluding gauging water.

9. The method of claims 1-8, wherein the water-resistant gypsum article absorbs less than about 10 percent water when tested in accordance with the immersion test of ASTM method C-2473.

10. The water-resistant gypsum article of claims 1-9, wherein the article comprises a gypsum board, dry wall, a gypsum wallboard, a gypsum lath, a tile-backing board, or gypsum sheathing.

11. A method of manufacturing a water-resistant gypsum board, comprising:
sonicating a water-resistance additive in water with a sonication device configured to impart ultrasonic energy to the additive and the water, to form a emulsion;
combining the emulsion, calcined gypsum, and gauging water to form a gypsum slurry;
dispensing the gypsum slurry onto a first facing sheet;
disposing a second facing sheet on a side of the dispensed gypsum slurry opposite the first facing sheet; and
setting the gypsum slurry to form the water-resistant gypsum board.

12. The method of claim 11, wherein the sonicating is at a power and for a time effective to substantially completely disperse the water-resistance additive in the water.

13. The method of claims 11-12, comprising operating the sonication device at a frequency of about 1 kilohertz to about 90 kilohertz.

14. The method of claims 11-13, further comprising adding a set accelerator, set retardant, foaming agent, reinforcing fiber, fire-resistance agent, viscosity control agent, emulsifying agent, or a combination comprising at least one of the foregoing to the emulsion and/or the slurry.

15. The method of claims 11-14, wherein the water-resistance additive comprises a wax, wax-asphalt, asphalt, metallic resonate, cornflower and potassium permanganate, water-insoluble thermoplastic organic material, thermoplastic synthetic polymer, metal rosin soap, water-soluble alkaline earth metal salt, fuel oil, aromatic isocyanate, aromatic diisocyanate, organopolysiloxane, siliconate, or a combination comprising at least one of the foregoing water-resistance additives.

16. The method of claims 11-15, further comprising adding the emulsion to the slurry in an amount effective to provide about 0.01 weight percent to about 20.0 weight percent of the water resistance additive, based on the total weight of the ingredients in the article, including the water of the emulsion and excluding gauging water.

17. The method of claims 11-15, wherein the water-resistance additive comprises poly(methyl hydrogen siloxane), a siliconate, or a combination comprising at least one of the foregoing water-resistance additives.

18. The method of claim 11, further comprising adding the emulsion to the slurry in an amount effective to provide about 0.01 weight percent to a bout 20.0 weight percent of the poly(methyl hydrogen siloxane), siliconate, or combination, based on the total weight of the ingredients in the article, including the water of the emulsion and excluding gauging water.

19. The method of claims 11-18, wherein the water-resistant gypsum article absorbs less than about 10 percent water when tested in accordance with the immersion test of ASTM method C-2473.

20. A water-resistant gypsum board, comprising
a gypsum core having a planar first face and a second face, wherein the core comprises about 0.01 weight percent to about 20 weight percent of organopolysiloxane, siliconate, or a combination comprising at least one of the foregoing, based on the total weight of the ingredients in the core, exclusive of gauging water; and
a facing material adhered to at least the first face of the gypsum core.

21. A system for producing a water-resistant gypsum slurry, comprising:
a sonication device configured to impart ultrasonic energy on a water-resistance additive in water to substantially completely disperse the water-resistance additive in the water and form a emulsion; and
a pin mixer in fluid communication with the sonication device, wherein the pin mixer is configured to thoroughly mix a calcined gypsum, gauging water, and the emulsion to form a gypsum slurry.

22. The system of claim 21, further comprising a feed tree configured to direct at least one of the calcined gypsum, water, and emulsion into the pin mixer.
